(19) United States
(12) Patent Application Publication
(10) Pub. No.: US 2002/0184170 A1
(43) Pub. Date: Dec. 5, 2002

(54) Hosted data aggregation and content management system

(76) Inventors: John Gilbert, Austin, TX (US); Dave Hawkins, Austin, TX (US)

Correspondence Address: Steven R. Greenfield, Esq., Jenkens & Gilchrist, P.C., Suite 3200, 1445 Ross Avenue, Dallas, TX, 75202-2799, US

(21) Appl. No.: 09/872,393

(22) Filed: Jun. 1, 2001

(51) Int. Cl. G06F 15/18

(52) U.S. Cl. 706/20

(57) ABSTRACT

A system and method for data aggregation and content management are disclosed. In addition, the data aggregation and content management service provided is a hosted or managed service that operates in a location distal from a plurality of client sites. The data aggregation and content management may be provided by a Web-based application. The client sites may be located throughout a geographical region, country, or across the world. The data is pulled or extracted from the client sites and then “standardized” according to predetermined requirements for usage either alone or as a conglomerate of standardized data. The data aggregation and content management may be controlled, to some degree, by the clients via an Internet-based control system. The client or customer can validate and/or monitor the processing of the data as it takes place via the Internet-based control system.

### BACKGROUND OF THE INVENTION

1. Field of the Invention

The present invention relates generally to an Internet-based data aggregation and content management method and system that support the retrieval of data from multiple sources as well as transformation of the data for distribution in a predetermined structured format as required by an end user.

2. Description of Related Art

Digital marketplaces, electronic storefronts, corporate portals, and Web-based enterprise applications are changing how businesses transact, communicate and interact. Start-up “dot-com” companies and “brick-and-mortar” companies alike in every type of industry are leveraging the Internet and employing Web-based technologies to redesign various aspects of their businesses. In particular, Web-based technologies are being used to redesign core business transaction oriented activities such as sales and purchasing as well as broader business processes such as customer relationship development and supply chain management.

Although these Web-based business transaction oriented efforts vary in the type and scope, they all share a common foundation, i.e., each relies on the use of data or “content.” Such content may include, for example, pricing information, customer contacts, inventory levels, market rates, engineering data, or any other type of data that may be related to the transactions. In a typical case, the content is aggregated or accumulated from a number of different sources and then categorized into ordered sets of information such as catalogs or databases that can be easily searched by a wide range of users. Moreover, certain types of transactions, e.g., e-commerce, e-business, Web-based forms, or other Internet based transactions (hereinafter “e-transactions”) may require dynamic content such as live or current product pricing, product availability, production capacity, search results, etc.

Traditional companies and organizations are finding it difficult to get a handle on such content. These companies are generally not in the data organization business and have come to the realization that the effort requires a large investment in new computers, software, staff and consultants to aggregate, categorize and manage the content effectively. Typically, a company has to purchase a software tool such as a database software sold by one of a number of vendors. The software tool has to be installed at one or more of the company sites of operation. Installation of the software tool often requires the purchase by the company of one or more dedicated computer systems to install the software tool on.

Once the software tool was installed, the company has to hire dedicated software/ computer employees or consultants to figure out how to use the software tool in conjunction with the needs of the company. The consultants have to develop software scripts, program codes, or other instructions sets to enable the extraction or collection of data. The data then has to be parsed, cleansed, validated, and translated or formatted in order to produce a desired output from the software tool using the associated computer systems.

Because the technical expertise often had to be provided by specialists, the cost to the company for these services can be very expensive. Furthermore, even if the specialists determined how to gather the data and produce the desired content, the process remained largely a manual one in that each iteration had to be performed separately. In addition, the company typically needed to aggregate the data many times. The aggregation may have to be performed on a real-time basis or on a scheduled basis (e.g., nightly or weekly). The constant need for data aggregation in turn created a large maintenance issue for the company. As a result, the company had to hire and maintain additional employees or consultants to monitor the tasks on a daily or 24 hour basis. Other issues may arise related to the data aggregation, for example, how to handle different types of data, duplicative records, software bugs, missing records, missing data, and the like. These requirements are not only expensive to a company, but are also continuous.

Therefore, what is needed is a way for companies who need, but who are not in the business of handling or simply do not want to handle data aggregation and content management, to be able to outsource such efforts at a low cost. Such a solution would ideally require these companies to make little or no change to their existing infrastructures.

### SUMMARY OF THE INVENTION

The present exemplary embodiments of the present invention provide a system and method for data aggregation and content management. In addition, the data aggregation and content management service provided is a hosted or managed service that operates in a location distal from a plurality of client sites. The data aggregation and content management may be provided by a Web-based application. The client sites may be located throughout a geographical region, country, or across the world. The data is pulled or extracted from the client sites and then “standardized” according to predetermined requirements for usage either alone or as a conglomerate of standardized data. The data aggregation and content management may be controlled, to some degree, by the clients via an Internet-based control system. The client or customer can validate and/or monitor the processing of the data as it takes place via the Internet-based control system.

In one aspect, the invention is directed to a method of hosting data aggregation and content management. The method comprises the steps of extracting data from a plurality of data sources to an off-site location and parsing the extracted data into at least one data field. The parsed data is then formatted into a predetermined format, and delivered from the off-site location to at least one content recipient.

In another aspect, the invention is directed to a hosted data aggregation and content management system. The system comprises at least one server computer which is located off-site relative to a plurality of data sources. The server computer is configured to extract data from the plurality of data sources and parse the extracted data into at least one data field. The parsed data is then formatted into a predetermined format and delivered to at least one content recipient.

### BRIEF DESCRIPTION OF THE DRAWINGS

A more complete understanding of the method and apparatus of the present invention may be had by reference to the following detailed description when taken in conjunction with the accompanying drawings wherein:

FIG. 1 is a high level system diagram of an exemplary embodiment of the present hosted data aggregation and content management system;

FIG. 2 is a more detailed system diagram of an exemplary embodiment of the present hosted data aggregation and content management system; and

FIG. 3 provides exemplary functional connection and uses of the preferred exemplary embodiments of the present data aggregation and content management system.

### DETAILED DESCRIPTION OF PREFERRED EXEMPLARY EMBODIMENTS

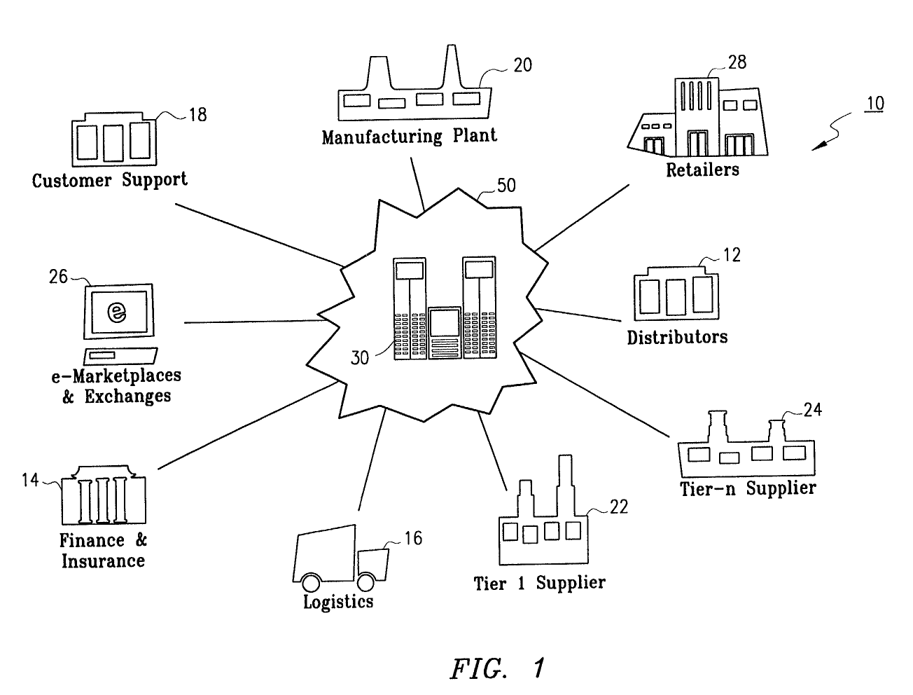

The various embodiments of the present invention and its advantages are best understood by referring to FIGS. 1-3 of the drawings, wherein like numerals refer to like and corresponding parts.

The present exemplary embodiments provide a unique and extremely useful approach and solution to data aggregation and content management. In one exemplary embodiment, a Data Aggregation and Content Management System (hereinafter DACMS) provides a hosted or managed Web-based content integration system and method. In general, “data” refers to the different types of data and information that can be retrieved by the DACMS from a plurality of sources, and “content” refers to the customized or enhanced data delivered by the DACMS to clients or end users. Hosted or managed means the DACMS functions are provided from an off-site location instead of on-site at each company or client. Web-based means the DACMS is accessible from the Internet using any of a number of commercially available Web browsers. Integration refers to the process whereby the DACMS collects the data, both static and dynamic, in virtually any organized data format from a plurality of data sources and transforms the collected data into structured content that can support e-transactions. The term “off-site” not only indicates a location geographically distal to the data sources, but may also indicate an organizational disassociation from the data sources.

The exemplary DACMS can provide an advantage to many businesses operating in digital marketplaces, on-line portals, or who are creating a business solution that relies heavily on the ability to acquire, manage, and deliver information that is accurate, current and relevant to the needs of the end user. The exemplary DACMS can further provide data enhancement options and quality assurance functions that provide data “scrubbing” to improve the accuracy and relevance of the content delivered. Furthermore, the exemplary DACMS provides a highly scalable platform that can address a multitude of content management situations without requiring a company or business to change or disrupt its existing technology or cost structures.

Moreover, effective management of content requires the continual execution of a series of complex data manipulation activities. The exemplary DACMS can provide data parsing, cleansing, normalization, validation, transformation, and delivery of content in virtually any format required by the end user or client.

Data parsing can include parsing of both textual data (e.g., product information, inventory status, order requests, etc.) and non-textual data (e.g. digital images, schematics, video, sound, etc.).

The data may be obtained from a number of disparate sources. For example, accessible systems from which data can be obtained range from a “Web Store Front” or a Point Of Sale (POS) device to an internal production planning system or an external supplier's inventory database.

The data to be parsed can be acquired through various communication means including regularly scheduled modem dial-ups, Web-based access, asynchronous Extensible Markup Language (XML), File Transfer Protocol (FTP), or any other type of on-line access.

The data can be copied and uploaded in real-time based on predetermined triggers (e.g., a sale, change in inventory status), or through manual intervention by either customer or data-source organizations.

The exemplary DACMS can perform the data collection or extraction in accordance with predetermined business rules. Such rules can be set up and established by the DACMS administrator and/or remotely by the clients or data source organizations. The rules can be applied globally to all data source organizations or locally to one or more particular businesses. Such open extraction procedures made available by the exemplary DACMS enable very flexible collection and delivery of content across the supply chain without impacting the technology and/or computer infrastructures of the participating companies. Moreover, once extracted, the data can be gathered and processed at an off-site central location regardless of where the data or source company may have been located originally.

After extraction, the exemplary DACMS “cleanses” the data to substantially ensure quality, completeness, and accuracy of the data. Using predetermined rules, the exemplary DACMS checks, for example, that the copied data is represented in the appropriate data fields, that there is no (or limited) data duplications, and that the data is “logical” (e.g., numerical data appears in fields requiring numerical data) and does not fall outside predetermined ranges or tolerances. The exemplary DACMS can correct a large majority of data errors “automatically” by using known system re-load techniques and correction algorithms. The result is customized or enhanced data that has added value to the end user thereof.

The exemplary DACMS then standardizes or “normalizes” the data such that they appear as though they came from a single data source. For example, oftentimes the same component may be labeled or described differently by two different manufacturers. Normalization may entail using a standard name or description for that component so that a proper analysis or comparison of the manufacturers may be rendered.

The exemplary DACMS then categorizes or transforms multiple data elements collected from potentially disparate systems into relevant content such as inventory status of a particular part or product in a particular location. Content can be cross-referenced against multiple look-up tables in order to support the comparison of related content, such as the availability of product at one company location versus another location.

Finally, the exemplary DACMS delivers the enhanced or customized data sets in the data format or file specification required by the end user or client. The enhanced data can be provided to the end user in multiple ways ranging from XML to direct-to-database exports. This exemplary process can significantly reduce costs associated with managing content by enabling data source companies or organizations to “publish” data once to the exemplary DACMS for aggregation, transformation, and distribution to multiple entities/recipients.

A Web-based intranet administrator application associated with the DACMS enables customers and data source organizations to monitor the content management activities of the DACMS, or to manage other aspects of the data aggregation and content management, in near real-time through a common Web browser tool. The exemplary intranet administrator application provides authorized users with an integrated view of data from multiple, disparate systems residing within and across business enterprises. Access to the content, data, or to the DACMS systems is determined by role-based permissions, thereby enabling a system administrator (and other authorized personnel) to access menus and other control features of the application, as well as the data being processed.

The exemplary DACMS can serve as a Web-based supply chain information network that can aggregate and deliver, at the customer's demand, production plans, engineering data, inventory, capacity, and other information to thereby aid in the optimization activities across the supply chain. For example, a PC manufacturer might use the exemplary DACMS to capture orders from a Web-based storefront and to parcel off requests to the appropriate suppliers for the components or sub-assemblies required to fill the order. Likewise, suppliers may upload inventory and capacity status to the DACMS to enable the PC manufacturer to better plan its production schedules. The intranet administrator application can be used for tracking how individual users, business units, or trading partners are complying with data requirements as well as to evaluate the quality of the data being delivered to participants.

FIG. 1 is a high level system diagram of a method of doing business 10 using an exemplary embodiment of the present hosted Data Aggregation and Content Management System (DACMS) 50. The business method 10 in FIG. 1 somewhat resembles a hub system in appearance in that a plurality of remote business entities 12-28 are linked to the DACMS 50. In general terms, the exemplary DACMS 50 serves as an exchange to facilitate the transfer of data or content between the business entities 12-28. Various types of data or content is obtained by the exemplary DACMS 50 from one or more of the entities and then processed in a manner that will be described in more detail below. The enhanced data is then provided as part of a service to other ones of the entities 12-28.

By way of example, consider the case of distributors 12 that may be selling consumer products. As each consumer product is sold, information regarding the sale is recorded in that distributor's respective product database. The DACMS 50 collects or otherwise extracts this data from the databases of the distributors 12 and provides the data in a specified format to a client or end user. In the case of an automobile, for example, the type of data the DACMS 50 may be set up to extract could include data related to the make, model, mileage, year, color, options package, financing terms, salesman, buyer, etc., for every vehicle sold by the distributors 12.

One of the many advantages of the exemplary DACMS 50 is that the data may be extracted in the format normally used by the distributor 12 and then converted later to a format required by the end users. Thus, there is usually no need for the distributor 12 to change or modify its existing data or technology infrastructure to accommodate the DACMS 50.

The DACMS 50 then processes the extracted data into enhanced data for distribution to one or more of the entities 12-28. For example, interest rates and other financial data may be sent to a finance and insurance entity 14 that specializes in financial and insurance services. Similarly, statistics and other logistics data may be provided to logistic entities 16 that control and manage the logistics of a business or transaction. Customer support entities 18 may require contact information for contacting consumers and purchasers. Manufacturers 20 may send part numbers and purchase order numbers to their suppliers, tier-1 suppliers 22 through tier-N suppliers 24, to replenish inventory. E-Marketplaces 26 may need data specifically geared for Internet based services. Finally, retailers 28 may need pricing and availability information for products sold in their stores. Any one of these entities may provide the nexus of data that can be extracted and forwarded to any other one of these or still other unlisted entities that require or would like to have the data.

Another advantage of the exemplary DACMS 50 is that it can be located in a single location, yet is able to support worldwide processing of data from a multitude of locations. In one embodiment, the exemplary DACMS 50 may be implemented on one or more high-end servers 30 such as Sun Microsystems's SPARC (TM) based servers running Sun's Solaris (TM) operating system. Alternatively, a UNIX-like operating system such as Linux may be used to control the servers 30. In a preferred embodiment, the servers 30 may be connected to one another to form an intranet (not shown). The intranet may, in turn, be connected to the Internet to thereby link the DACMS 50 thereto.

The exemplary DACMS 50 may further have a series of Redundant Arrays of Inexpensive Disks (RAID) storage towers (not shown) for storing the extracted data. These RAID towers may be expanded as needed to provide additional storage capacity.

A plurality of modems and/or communication devices (also not shown) serve to connect the exemplary DACMS 50 to the business entities 12-28. In a preferred embodiment, the plurality of modems and/or communication devices is similar to that which is described in commonly assigned U.S. patent application Ser. No. ______, filed ______, and incorporated herein by reference.

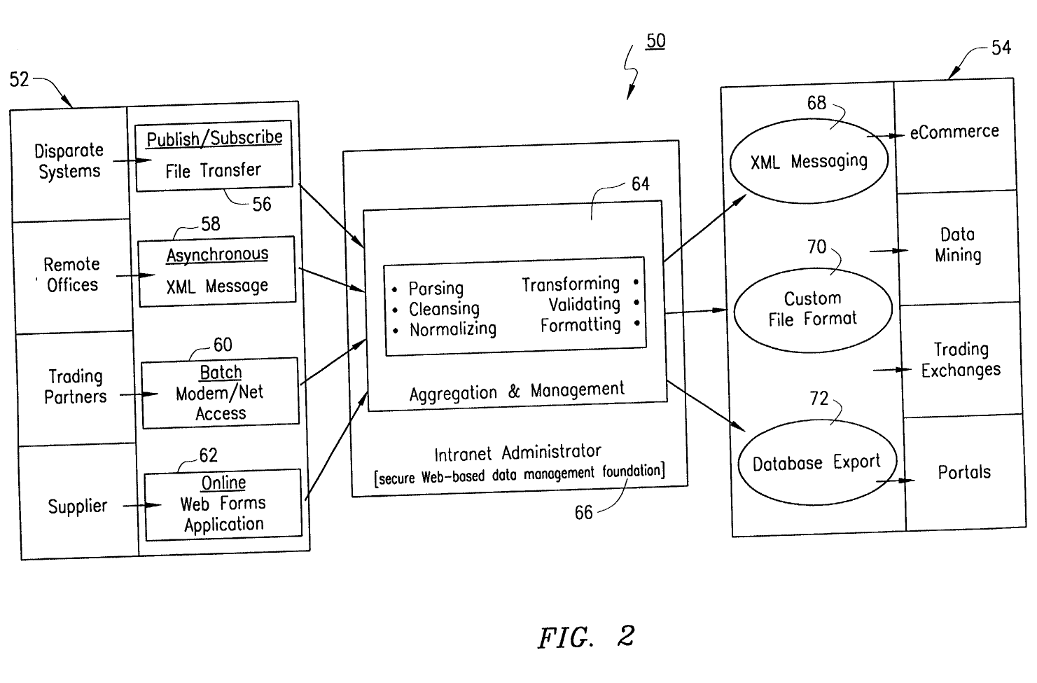

FIG. 2 depicts a system diagram of the exemplary DACMS 50 in more detail. On the far left side of FIG. 2 are a number of exemplary data sources 52 from which business data can be obtained by the DACMS 50. Such data sources 52 often include disparate systems wherein the computers cannot communicate with each other due to differences in their hardware and/or software. Such data sources 52 may also include remote offices of the same company such as in the case of a multinational corporation. Data relating to company assets, sales, inventory, R&D, or payroll information often need to be aggregated from such remote offices on a relatively frequent basis Other examples of data sources 52 may include companies that have special business relationships with each other such as the relationship between trading partners or between a company and its suppliers.

On the far right side of FIG. 2 are a number of content recipients 54 that receive the process or enhanced data from the DACMS 50. Such content recipients 54 may include e-commerce entities, entities that specialize in data mining, entities that facilitate trading such as exchange companies, entities that serve as Internet portals, or any other entities that have a need or rely on the data.

The aggregation of data from the data sources 52 may be accomplished via a variety of data transfer mechanisms. For example, under a publish/subscribe model 56, the data sources 52 simply publish their data on, e.g., a Web site, and the DACMS 50 may obtain this data directly from the Web site. In this model, the DACMS 50 may initiate a data transfer by establishing a connection to the Web site via the Internet and downloading the data. Alternatively, the data could also be “pushed” (sent) to the DACMS 50 via the Internet from the publisher site.

Asynchronous or real-time XML messaging 58 is a transfer mechanism whereby as soon as a new data entry occurs at the data sources 52, the computer system thereof generates an XML message containing the data. The XML message is then sent immediately to the DACMS 50 via the Internet for processing.

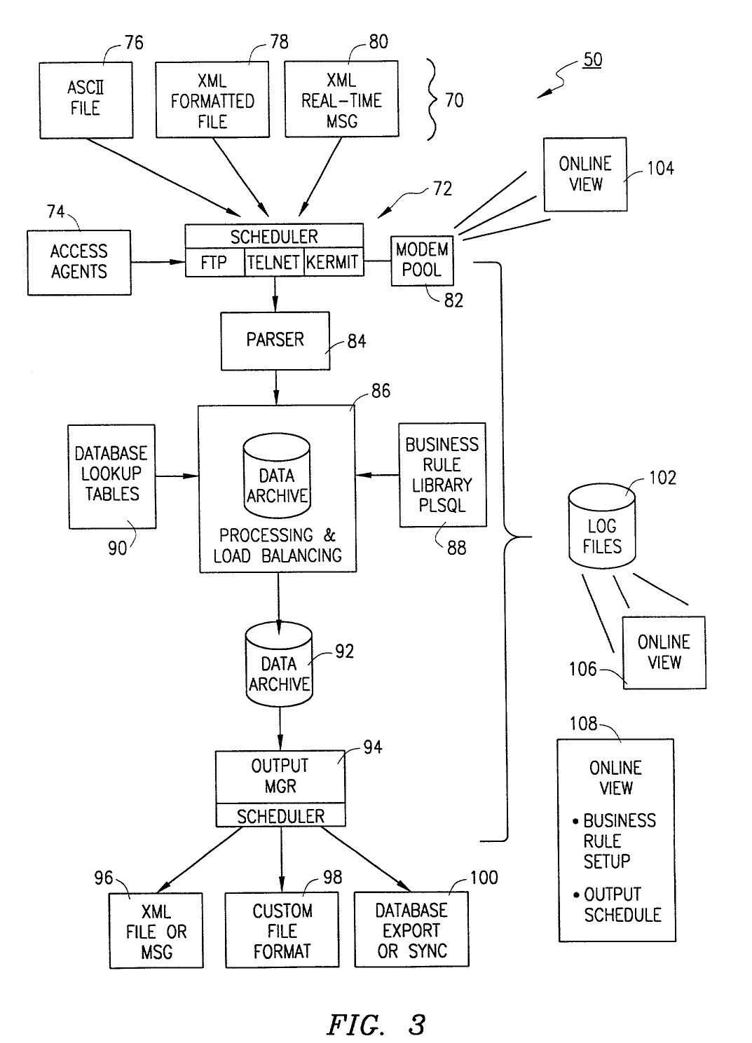

Batch accessing 60 is a transfer mechanism that relies on modem or network access to obtain the data from the data sources 52. This technique uses a bank (not shown) of modems and/or other type of communication devices that are pooled together to access the data from the data sources 52. The data access jobs are usually executed in batches, i.e., multiple access jobs may be executed at same time by different modems and/or communication devices on a scheduled basis. A scheduling application (shown in FIG. 3) assigns new access jobs to the modems and/or communication devices in the pool as each device becomes available after completing its previous assignment.

On-line access 62 generally refers to any transfer mechanism that takes place on-line. One particular on-line access method 62 uses a Web-based form that allows a user/customer to enter information directly into the DACMS 50 via the Internet. In a typical application, a user can complete a purchase order or repair request on-line by connecting to a predetermined Web site. The form is then transferred to the DACMS 50 for processing.

It should be noted that any of the data sources 52 may use any of the data transfer mechanisms 56-62 and that, in general, one does not limit the use of the other and vice versa.

At the heart of the DACMS 50 are two modules, an aggregation and management module 64 and an intranet administrator module 66, that operate in conjunction with each other. In general, the aggregation and management module 64 is responsible for taking the data extracted from the data sources 52, enhancing the data, putting it in a format that can be used by the content recipients 54, and delivering the content to the content recipients 54. The intranet administrator 66 facilitates the various administrative tasks associated with the DACMS 50 such as setting up user accounts, verifying security authorization, and monitoring the data extraction process. A description of each module follows.

Within the aggregation and management module 64 are a number of functions that are performed on the extracted data including: parsing, cleansing, normalizing, transforming, validating, and formatting data.

Basically, parsing is the process of determining the symbolic structure of a data file or string of symbols in some computer language and placing the key pieces of information into predetermined data fields for later use. The data to be parsed may be stored in a number of differently organized formats at the various data sources 52. For example, at some data sources, each data field may be separated by a comma or space, while at other data sources the size of each data field may be a fixed width (e.g., 10 characters). In some exemplary embodiments, the specific data fields and associated delimiters for each data source 52 have been pre-stored in a template or otherwise preprogrammed. The DACMS may then apply the templates to the extracted data and construct the records and data fields accordingly. In other exemplary embodiments, however, the parsing function determines the data fields and delimiting method upon receipt of the data from each data source 52, then breaks the data down into individual records and fields accordingly. The data records and fields, which may number in the thousands or hundreds of thousands, may thereafter be processed and provided to a content recipient 54. For example, an exemplary embodiment may parse auto industry related data into data fields such as inventory information, sales transactions, service transactions, parts lists, parts catalogs, etc., that can used by the content recipients 54 in the automobile industry.

The next process that may occur is the data cleansing function. Cleansing of the data includes such tasks as correcting misspelled words, flagging records that are missing data, removing duplicate records, and in some cases, augmenting data records by adding information to the records from related data. For example, if a serial number of an automobile part is known, then the part name and possibly the car make and model can be determined. Furthermore, if the make and model of a car is known, but an error is found in a related serial number, then portions of the serial number or car part may be corrected based on the make and model. Known correction algorithms such as spell checkers can be incorporated as needed into the cleansing process.

Generally, after cleansing, the data may be normalized. The normalizing function basically removes inconsistencies between otherwise similar or identical data. For example, inventory data retrieved from two different data sources 52 may refer to the same part by a different name or description (e.g., Delco radio vs. Delco stereo). The normalizing function resolves these inconsistencies into predetermined standard units or wording such that all the information looks as though it came from a single standardized system.

Next, the original data may be transformed into a new or different type of data. For example, the transformation function may derive new data fields that combine two or more separate data fields. The derived fields may be obtained, for example, using mathematical operations like taking averages or sums of differences.

Once the data has been transformed, validation may be performed to ensure that the data complies with certain predetermined requirements. Validation may include such tasks as seeking out missing data, flagging records that have problems, and logging the problems. Validation may also include making sure the data file was extracted or copied in its entirety from the data sources 52 by, for example, making sure that the extraction was not interrupted or prematurely terminated.

After validation, the data may be formatted by the formatting function in order to put the data into a format that is required by the content recipients 54. For example, the formatting function may create a custom file format 70 such as a fixed width and/or comma delineated format. The data also may be formatted as a real-time or asynchronous XML message 68 where such messages are required by the content recipients 54. Furthermore, the formatting function may create a database 72 that can be exported, then loaded directly into the databases of the content recipients 54. It should be noted that although only three formats have been listed, other formats known to those of ordinary skill in the art may also be used without departing from the scope of the invention.

Additionally, although the functions of the exemplary DACMS 50 were described in a particular order, the order of these functions is not important. For example, the processes of cleansing and normalizing functions may be performed before the extracted data is parsed.

Furthermore, some of the functions may be eliminated in certain circumstances. For example, some data sources 52 already validate the data at the point of entry. In such cases, the validation function may be omitted. Likewise, the transformation function may also be skipped if, for example, the data coming into the DACMS 50 is already of the same type as required by the content recipients 54. Other functions may also be skipped where appropriate as determined by the content recipients 54. In general, only the parsing and formatting functions are required to be performed in a preferred exemplary DACMS. Parsing is usually required because the extracted data needs to be put into some type of structured format that renders the data amenable to processing. Formatting is usually required so that the data will be delivered in a form that is usable to the content recipients 54.

As mentioned earlier, the intranet administrator module 66 is responsible for facilitating the various administrative functions associated with the DACMS 50. In a preferred embodiment, the intranet administrator 66 is a secure Web-based interface that allows the DACMS 50 administrative staff as well as authorized personnel from the data sources 52 and content recipients 54 to access the DACMS 50. Because the intranet administrator 66 is Web-based, such access may take place via the Internet using any commercially available Web browser. As such, any authorized personnel may use the intranet administrator 66 regardless of their location as long as they have Internet access from that location. Preferably, all personnel wishing to use the intranet administrator 66 to access the DACMS 50 must have an account set up including at least a unique login ID and password. Furthermore, higher levels of access may be granted to certain personnel and withheld from others based on their security authorization.

Upon successful login, the authorized personnel may manage, view, or oversee the “jobs” presently running or scheduled to be run by the DACMS 50. For example, a content recipient 54 personnel may log in to the intranet administrator 66 to confirm that the content being received has been processed according to specifications. Other tasks facilitated by the intranet administrator 66 include setting up user accounts, changing security codes, viewing job statuses, and allowing an authorized personnel to control certain aspects of the DACMS 50.

Referring now to FIG. 3, a diagram of the functional components of an exemplary DACMS 50 is depicted. A few exemplary types of data files to be extracted by the DACMS 50 are shown at 70 including, for example, ASCII files 76, XML formatted files 78, and XML real-time messages 80.

A scheduler 72 determines the sequence or order in which each access job is to be performed. The order assigned by the scheduler 72 may depend on a number of factors including the time zone of the data sources 52, the amount of data traffic experienced thereon, the size of the data files, a prearranged agreement with the data sources 52, or any other suitable factors. Once assigned, however, an access job is executed only according to its assigned slot.

A plurality of access agents 74 provide the scheduler 72 with detailed instructions regarding how to access and extract the data from the data sources. An access agent 74 is generally are software plug-ins that are created to enable the access of various computer systems and/or computer platforms. Each access agent 74 is specific to that system or platform and allows the DACMS 50 to be in communication with any system for which an access agent can be created. By utilizing access agents, the main DACMS software modules do not require modification, only the plug-ins need to be added or modified.

A modem pool 80 similar to the modem pool discussed earlier provides the means for bringing the extracted input data into the DACMS 50.

A parser 84 parses the extracted data into predetermined records and fields. The parsed records and fields are thereafter placed into a temporary database 86 for subsequent processing (e.g., cleansing normalizing, transforming, validating, etc.) In a preferred embodiment, the temporary database 86 is a commercially available database such as an Oracle™ database.

Often, there may be more data files to be processed in the temporary database 86 than a single data processing machine can handle effectively. In that case, a load balancing system can review the size of the files and the amount of processing required and, if necessary, shift some of the processing load to one or more other processing machines (not specifically shown). In this way, processing of the data files may be balanced amongst the available processing machines so that no one machine is overloaded. Such an arrangement allows additional equipment to be easily added commensurate with expected or realized increases in the processing load.

During the cleansing, normalization, transformation and validation functions, a plurality of predetermined business rules 88 may be applied to the data. The business rules 88 are basically procedures established by the data sources 52 and/or the content recipients 54 to ensure the data complies with certain requirements. For example, the business rules 88 may require that purchase prices over $5,000 be flagged, or all retail prices be set to 1.25 times the wholesale price, or all descriptions be placed in alphabetical order. Furthermore, a database look-up table 90 may provide information used in the correction of data such as invalid product serial numbers or automobile VIN numbers in the data. The look-up table 90 also contains predetermined standards for use with the normalizing function.

The processed data is then passed to a data archive 92 for storage prior to delivery to the content recipients. The duration of the storage in the data archive 92 may vary depending on the requirements of the content recipients. For example, the data may be stored only for a moment, for 24 hours, a week or possibly years.

Once the data is stored in the data archive 92, an output manager 94 controls when to deliver the data to the content recipients. For example, the output manager 94 may determine whether the original data was real-time triggered so that as soon as the corresponding processed or enhanced data is placed in the data archive 92, it is sent out immediately to the content recipients. Alternatively, the output manager 94 may set up scheduled times for sending the enhanced data files to the content recipients based on a prearranged agreement therewith or some other factor. The data may be delivered to the content recipients in any specified format such as an XML file or message 96, a custom file format 98, or a database export format 100.

A logging database 102 records information regarding every operation of the data aggregation and content management service performed by the DACMS 50. The type of information stored may include whether the data was extracted and processed, what time processing started and ended, any errors that may have occurred, who the data source is, who the content recipient is, and any other information that may be considered relevant and useful.

A number of on-line views are available through the intranet administrator 66 to authorized members of the DACMS 50 administrative staff, data sources, and content recipients. Because the intranet administrator 66 is a Web-based application, these on-line views may be accessed from virtually any location via the Internet using a Web browser.

For example an on-line view 104 of the modem pool 80 allows authorized personnel to view specific information about the access jobs that are currently running and scheduled to be run. The authorized personnel may further control the access jobs by manually removing or rescheduling specific access jobs or setting up new access jobs to be run.

A log file on-line view 106 allows authorized personnel to view specific information stored in the logging database 102. This information allows an authorized personnel to detect trends in the operation of the DACMS 50. For example, a high number of errors being consistently logged during a certain part of the day may be an indication of recurring adverse conditions during that time.

An on-line view 108 of the output manager 94 allows the authorized personnel to view specific information about the content delivery schedule such as the data format for a particular delivery and whether correct data is being delivered. Furthermore, the authorized personnel may set up impromptu content deliveries or cancel a delivery as needed.

Another embodiment of the present invention allows the DACMS 50 to write data back to an initiating remote computer system in the form of an ASCII file 76, an XML formatted file 78, an XML real-time message 80, or another acceptable data format. This technique allows for a two way communication, rather that a one-way (read-only) transfer of data from the source. The significance of writing back to the source in a bidirectional manner is that it allows the DACMS to handle transactions rather than just data extraction. By allowing the DACMS to handle transactions such, such as the buying or selling of an automobile, goods procurement or service procurement, or the requesting and responding to questions and inquiries, the DACMS can be used to complete eCommerce transactions over a global computer network, such as the Internet, without human intervention. The process is similar to the data extraction process depicted in FIG. 3, except the data is provided back to the originating source via ASCII, XML, XML real-time, or acceptable data formats. The data being sent back may be inserted into the screen that a user is viewing and using to send data to the DACMS to thereby correct input errors made by the a user or to fill in additional blanks for the user.

As such, the system does not simply emulate keystrokes of a user and enter them into appropriate places on the user's computer screen, instead the DACMS parses the data required for each screen that a user views and discriminates the definitions of each field description found on the screen. The appropriate data is then input into the appropriate field on the screen for the user to view. Thus, the topology of a screen may change, but the DACMS determines the correct place on a screen to place the data regardless of the order of the data.

For example, a user may enter an automobile make, model and production year into various blank locations on an Internet based screen. The make, model and production year data is sent, for example, via an XML real-time message to the DACMS along with other data field information associated with the screen the user is viewing. The data is scheduled, parsed, processed, passed by the look-up tables and business rules library of the DACMS. The data archive is utilized and output data is generated which is provided back to the user's screen to fill in blank field locations such as an automobile's price, physical location, milage, serial number, previous owner information, options, rated condition, or any other relevant data that is available and that may be provided to or incorporated into the screen the user is viewing to fill in any unfilled blank data locations. Human intervention is not required to provide such information back to the user, regardless of the format/location of the data on the viewer's screen. In effect, the DACMS determines what data is being requested and how to format it for the screen being viewed and used by the user and then sends the necessary data. This significant in that it allows the DACMS to scale itself to literally hundreds of thousands of different formats and systems each having different needs associated with the same data.

Although various preferred embodiments of the invention have been so shown and described, it will be appreciated by those skilled in the art that changes may be made to these embodiments without departing from the principles and the spirit of the invention, the scope of which is defined in the appended claims.

What is claimed is:

1. A method of hosting data aggregation and content management, said method comprising the steps of:
extracting data from a plurality of data sources to an off-site location;
parsing said extracted data into at least one data field;
formatting said parsed data into a predetermined format; and
delivering said formatted data from said off-site location to at least one content recipient.

2. The method according to claim 1, further comprising cleansing said parsed data including correcting any errors in said parsed data.

3. The method according to claim 1, further comprising normalizing said parsed data including conforming said parsed data to a predetermined standard.

4. The method according to claim 3, wherein said predetermined standard is stored in a look-up table.

5. The method according to claim 1, further comprising transforming said data including deriving at least one new data field from said parsed data.

6. The method according to claim 1, further comprising validating said parsed data including confirming said data extraction was completed successfully.

7. The method according to claim 1, wherein said plurality of data sources includes a selected one of disparate systems, remotely located offices, trading partners, and suppliers.

8 The method according to claim 1, wherein said data is extracted in a format presently used by said plurality of data sources.

9. The method according to claim 1, wherein said data is extracted using a selected one of a File Transfer Protocol, Telnet, Kermit, modem dial-up, Internet access, Extensible Markup Language message, and Web forms.

10. The method according to claim 1, wherein said predetermined format includes a selected one of an ASCII text, Extensible Markup Language message, database export, and custom file format

11. The method according to claim 1, wherein said content recipients includes a selected one of an e-commerce entity, a data mining entity, a trading exchange, and an Internet portal.

12. The method according to claim 1, wherein said data is extracted from each one of said plurality of data sources according to a predetermined schedule.

13. The method according to claim 12, further comprising controlling said predetermined schedule from an online view via the Internet.

14. The method according to claim 1, further comprising applying a predetermined set of rules to said parsed data.

15. The method according to claim 1, further comprising temporarily storing said parsed data in an archive

16. The method according to claim 1, further comprising balancing a processing of said parsed data amongst a plurality of data processing machines.

17. The method according to claim 1, wherein said formatted data is delivered to said at least one content recipient according to a predetermined schedule.

18 The method according to claim 17, further comprising controlling said predetermined schedule from an online view via the Internet.

19. The method according to claim 1, further comprising logging information regarding each step of said method of hosting data aggregation and content management.

20. The method according to claim 19, further comprising viewing said logged information from an online view via the Internet.

21. A hosted data aggregation and content management system, comprising:
at least one server computer, said server computer located off-site relative to a plurality of data sources and configured to:
extract data from said plurality of data sources;
parse said extracted data into at least one data field;
format said parsed data into a predetermined format; and
deliver said formatted data to at least one content recipient.

22. The system according to claim 21, wherein the server computer is further configured to cleanse said parsed data including correcting any errors in said parsed data.

23. The system according to claim 21, wherein the server computer is further configured to normalize said parsed data including conforming said parsed data to a predetermined standard.

24. The system according to claim 23, wherein said predetermined standard is stored in a look-up table.

25. The system according to claim 21, wherein the server computer is further configured to transform said data including deriving at least one new data field from said parsed data.

26. The system according to claim 21, wherein the server computer is further configured to validate said parsed data including confirming said data extraction was completed successfully.

27. The system according to claim 21, wherein said plurality of data sources includes a selected one of disparate systems, remotely located offices, trading partners, and suppliers.

28. The system according to claim 21, wherein said data is extracted in a format presently used by said plurality of data sources.

29 The system according to claim 21, wherein said data is extracted using a selected one of a File Transfer Protocol, Telnet, Kermit, modem dial-up, Internet access, Extensible Markup Language message, and Web forms.

30. The system according to claim 21, wherein said predetermined format includes a selected one of an ASCII text, Extensible Markup Language message, database export, and custom file format.

31. The system according to claim 21, wherein said content recipients includes a selected one of an e-commerce entity, a data mining entity, a trading exchange, and an Internet portal.

32 The system according to claim 21, wherein said data is extracted from each one of said plurality of data sources according to a predetermined schedule.

33. The system according to claim 32, wherein said predetermined schedule may be controlled by an authorized personnel from an online view via the Internet.

34 The system according to claim 21, wherein the server computer is further configured to apply a predetermined set of rules to said parsed data.

35. The system according to claim 21, wherein the server computer is further configured to temporarily store said parsed data in an archive.

36. The system according to claim 21, wherein the server computer is further configured to share a processing of said parsed data with another server computer.

37. The system according to claim 21, wherein said formatted data is delivered to said at least one content recipient according to a predetermined schedule.

38. The system according to claim 37, wherein said predetermined schedule may be controlled by an authorized personnel from an online view via the Internet.

39. The system according to claim 21, wherein the server computer is further configured to log information regarding each operation of said hosted data aggregation and content management system.

40. The system according to claim 39, wherein said logged information may be viewed online via the Internet.
